(19) United States
(12) Patent Application Publication
(10) Pub. No.: US 2007/0214282 A1
(43) Pub. Date: Sep. 13, 2007

(54) LOAD BALANCING VIA ROTATION OF CLUSTER IDENTITY

(75) Inventor: Siddhartha Sen, Bellevue, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/276,761

(22) Filed: Mar. 13, 2006

(51) Int. Cl. G06F 15/16

(52) U.S. Cl. 709/245

(57) ABSTRACT

A method and system for implementing load balancing via rotation of cluster identity is described herein. A cluster MAC address is associated with a first server in a cluster of servers. A switch forwards packets having the cluster MAC address as the destination address to the first server. A cluster identity is rotated from the first server to a second server in the cluster. The cluster MAC address is associated with the second server and disassociated from the first server. The second server sends a packet to the switch with the cluster MAC address as the source address. The switch forwards packets having the cluster MAC address as the destination address to the second server.

### BACKGROUND

Network load balancing solutions typically fall into two categories: hardware and software. Implementing a single-tier front-end server to distribute packets across target servers in a cluster does not typically require manipulation of the servers in the cluster. However, purchasing a high-end server or hardware load balancer to sit in front of the cluster can be very costly.

To avoid the purchase of expensive hardware, commodity switches and software sitting on each target server in the cluster may be used to achieve the desired load balancing results. The switch sitting in front of the cluster is configured to send each packet to every target server in the cluster. Software running on each target server then runs the same algorithm to decide whether to keep or drop the packet. For each packet, one server in the cluster will process the packet, while all the other servers in the cluster will drop the packet. This method achieves load balancing, but the flooding of packets to every target server consumes a lot of network bandwidth and causes the switch to operate suboptimally.

### SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

Described herein are various technologies and techniques directed to methods and systems for load balancing via rotation of cluster identity. In accordance with one implementation of the described technologies, a cluster identity is assigned to one of the servers in a cluster of servers. The MAC address of the server owning the cluster identity is replaced with a cluster MAC address. A packet is sent from the server owning the cluster identity to a switch. One or more packets may then be received at the server owning the cluster identity from the switch. After a predetermined amount of time, the MAC address of the server owning the cluster identity is replaced with its original MAC address. The cluster identity is rotated to another server in the cluster and the process is repeated.

In another implementation of the described technologies, one of the servers in a cluster of servers is assigned the cluster identity. A packet having the cluster MAC address as the source address is sent from the server owning the cluster identity to a switch. One or more packets may be received at the server owning the cluster identity from the switch. Any packets sent from any server that does not own the cluster identity has a source address that is different from the cluster MAC address. After a predetermined amount of time, the cluster identity is rotated to another server in the cluster and the process is repeated.

In another implementation of the described technologies, one of the servers in a cluster of servers is assigned the cluster identity. A request is received from a router inquiring which MAC address maps to a cluster IP address. A response is sent indicating that the MAC address of the server owning the cluster identity maps to the cluster IP address. The response may be sent from any of the servers in the cluster. Upon receipt of the response, the router updates its router table to map the MAC address of the server owning the cluster identity to the cluster IP address. Packets with the cluster IP address as the destination IP address are then forwarded to the server owning the cluster identity. After a predetermined amount of time, the cluster identity is rotated to another server in the cluster, and the process is repeated.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 is a block diagram illustrating an exemplary system for rotation of cluster identity via MAC address plumbing.

FIG. 2 is a block diagram illustrating an exemplary system for rotation of cluster identity via MAC address spoofing.

FIG. 3 is a block diagram illustrating an exemplary system for rotation of cluster identity via a mapping of a cluster IP address to a server MAC address.

FIG. 4 is a block diagram illustrating an exemplary two-tier system for rotation of cluster identity.

FIG. 5 is a flow diagram illustrating an exemplary process for rotation of cluster identity via MAC address plumbing.

FIG. 6 is a flow diagram illustrating an exemplary process for rotation of cluster identity via MAC address spoofing.

FIG. 7 is a flow diagram illustrating an exemplary process for rotation of cluster identity via a mapping of a cluster IP address to a server MAC address.

FIG. 8 illustrates an exemplary computing environment in which certain aspects of the invention may be implemented.

Like reference numerals are used to designate like parts in the accompanying drawings.

### DETAILED DESCRIPTION

The detailed description provided below in connection with the appended drawings is intended as a description of the present examples and is not intended to represent the only forms in which the present example may be constructed or utilized. The description sets forth the functions of the example and the sequence of steps for constructing and operating the example. However, the same or equivalent functions and sequences may be accomplished by different examples.

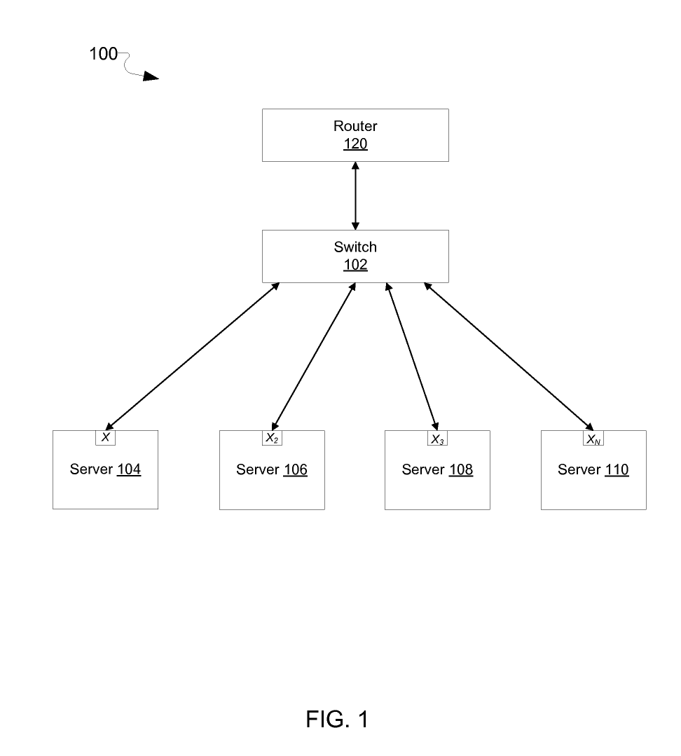

FIG. 1 is a block diagram illustrating an exemplary system 100 for rotation of cluster identity. Exemplary system 100 includes a router 120, a switch 102, and a plurality of servers, such as 104, 106, 108, and 110. A router table maintained by router 120 maps Internet Protocol (IP) addresses to Media Access Control (MAC) addresses. A load balancing system may configure each of its servers to have the same virtual IP address. For example, servers 104, 106, 108, and 110 may all have a virtual IP address of A. This virtual IP address of A may be mapped to a MAC address of X in the router table maintained by router 120. Each server has a unique MAC address. For example, server 104 may have a MAC address X₁, server 106 may have a MAC address X₂, server 108 may have a MAC address X₃, and server 110 may have a MAC address X_{N}. When a server sends an outgoing packet to switch 102, the switch 102 learns the MAC address of the server from the source address of the packet. For example, a packet sent by server 106 to switch 102 would have a source address of X₂. If none of the servers are configured to have a MAC address of X, then the switch may send each incoming packet, which has a destination MAC address of X, to each server in the system. Each server may then determine whether to process or discard the packet. This method may achieve load balancing, but may also flood the network.

Alternatively, load balancing may be achieved by rotation of cluster identity. The cluster identity may be assigned to one of the plurality of servers in system 100 and then rotated to another server after a predetermined amount of time. The MAC address of the server owning the cluster identity is changed to the cluster MAC address that maps to the cluster virtual IP address. For example, as shown in FIG. 1, server 104 is assigned the cluster identity. The MAC address of X₁ may be removed from server 104 and replaced with the cluster MAC address of X. Server 104 may send a packet to switch 102 with a source address of X, so switch 102 learns that MAC address X is associated with server 104. After switch 102 learns that MAC address X is associated with server 104, incoming packets that have a destination MAC address of X will be forwarded to server 104.

After a predetermined amount of time, the cluster identity is rotated from server 104 to another server in system 100. The rotation of cluster identity may be done randomly, in a round robin manner, or by any other method to achieve load balancing. The predetermined amount of time may also be selected randomly or by any other algorithm. For example, after a predetermined time of three seconds, the cluster identity may be rotated from server 104 to server 106. MAC address X would be removed from server 104 and replaced with the original MAC address of X₁. MAC address X₂ would be removed from server 106 and replaced with MAC address X. Then, server 106 may send a packet to switch 102 with a source address of X. The packet sent to switch 102 may be a gratuitous packet. For example, the packet sent to switch 102 may be a membership heartbeat packet, which is a packet sent from one server in the cluster to let the other servers in the cluster know that it is alive so every server in the cluster has a consistent view of the cluster membership. After receiving a packet from server 106 with the source address of X, switch 102 learns that MAC address X is associated with server 106 and forwards packets with a destination MAC address of X to server 106. Then, after a predetermined amount of time, the cluster identity would be rotated to another server in system 100. For example, after a predetermined time of three seconds, the cluster identity may be rotated from server 106 to server 108. MAC address X would be removed from server 106 and replaced with the original MAC address of X₂. MAC address X₃ would be removed from server 108 and replaced with MAC address X. Then, server 108 may send a packet to switch 102 with a source address of X. Switch 102 learns that MAC address X is associated with server 108 and forwards incoming packets with a destination MAC address of X to server 108. Then, after a predetermined amount of time, the cluster identity would be rotated from server 108 to another server in system 100. The process continues and incoming packets are appropriately load balanced among the plurality of servers in the system.

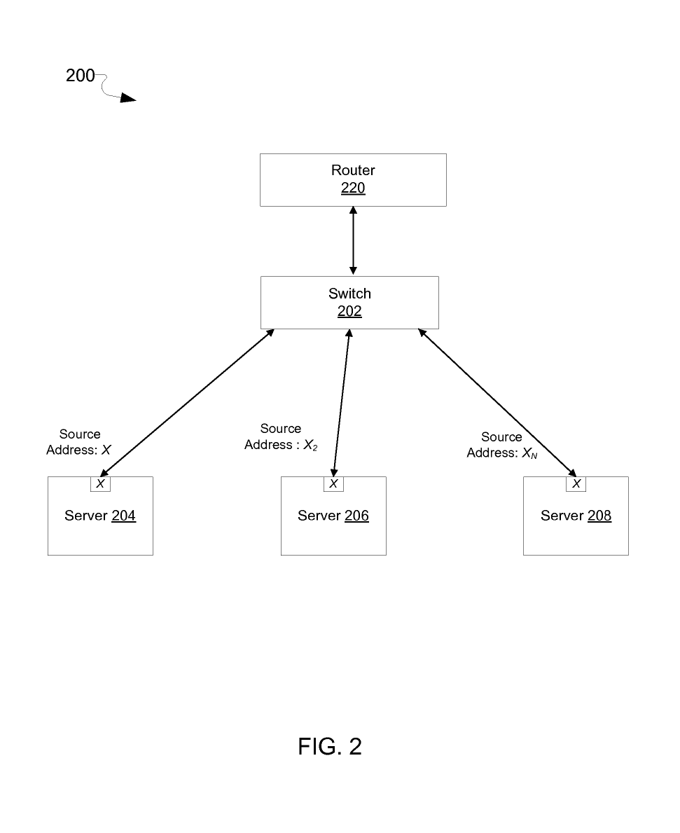

FIG. 2 is a block diagram illustrating an exemplary system 200 for rotation of cluster identity via MAC address spoofing. System 200 includes a router 220, a switch 202, and a plurality of servers, such as 204, 206, and 208. Each server in system 200 is configured to have the same virtual IP address and the same MAC address. For example, servers 204, 206, and 208 may each be configured to have a virtual IP address of A and a MAC address of X. The router 210 may maintain a router table that has an entry mapping IP address A to MAC address X. A cluster identity is assigned to one of the plurality of servers in system 200 and then rotated to another server in system 200 after a predetermined amount of time. When a server owns the cluster identity, the server will use the source address of X when sending packets. Other servers in system 200 that do not own the cluster identity will use a spoofed or modified source address when sending packets. For example, the cluster identity may be assigned to server 204. Server 204 would then use the source address of X when sending packets. Servers 206 and 208 would use spoofed or modified source addresses when sending packets. For instance, server 206 may use the source address X₂ when sending packets and server 208 may use the source address X_{N} when sending packets. Since server 204 is the only server that is using the source address X when sending packets, switch 202 learns that MAC address X is associated with server 204. Therefore, switch 202 will forward incoming packets with a destination MAC address of X to server 204.

After a predetermined amount of time, the cluster identity may be rotated to another server in the cluster. The server that owns the cluster identity would start sending packets with a source address of X. The other servers in the cluster would use spoofed or modified source addresses when sending packets. For example, after 10 seconds, the cluster identity may be rotated from server 204 to server 208. Server 208 would start using the source address X when sending packets. Servers 204 and server 206 would use spoofed or modified source addresses when sending packets. For instance, server 206 may use the source address X₂ when sending packets and server 204 may use the source address X₁ when sending packets. Server 208 may send a gratuitous packet, such as a heartbeat packet, to switch 202 so that switch 202 will learn that MAC address X is now associated with server 208. Switch 202 would then forward packets with a destination MAC address of X to server 208. After a predetermined amount of time, the cluster identity would rotate to another server in the cluster. The process continues and incoming packets are appropriately load balanced among the plurality of servers in the system.

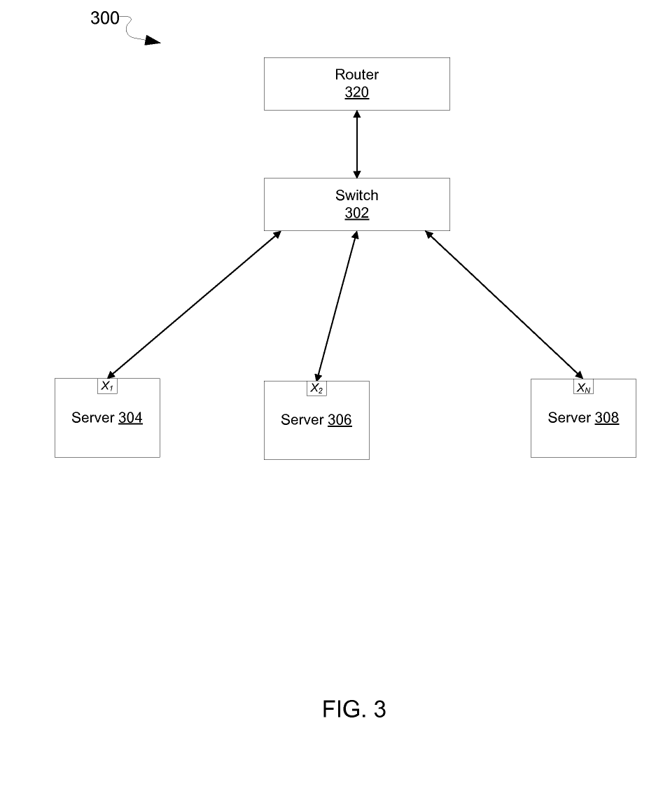

FIG. 3 is a block diagram illustrating an exemplary system 300 for rotation of cluster identity via a mapping of a cluster IP address to a server MAC address. System 300 includes a router 320, a switch 302, and a plurality of servers, such as 304, 306, and 308. Each server may be configured to have the same virtual IP address and a unique MAC address. For example, servers 304, 306, and 308 may each be configured to have a virtual IP address of A. Server 304 may have a MAC address of X₁, server 306 may have a MAC address of X₂, and server 308 may have a MAC address of X_{N}. A cluster identity is assigned to one of the plurality of servers in system 300. After a predetermined amount of time, the cluster identity is rotated to another server in the system 300.

The router 310 maintains a router table that maps IP addresses to MAC addresses. The router 310 may periodically send out a request to update a mapping of an IP address to a MAC address. The request may be an Address Resolution Protocol (ARP) request. The request sent by router 310 may ask which MAC address maps to a specified cluster IP address. One or more of the plurality of servers in system 300 would respond to this request from router 310 with the MAC address of the server that currently owns the cluster identity. For example, suppose the cluster identity is assigned to server 304, which has a MAC address of X₁. When router 310 sends out a request inquiring which MAC address maps to IP address A, server 304, 306, and/or 308 may respond to the request with the MAC address X₁. Upon receipt of the response to the request, router 310 would update its router table to map IP address A to MAC address X₁. Then, incoming packets with a destination IP address A would be forwarded to server 304.

After a predetermined amount of time, the cluster identity would be rotated to another server in the cluster. For example, after 5 seconds, the cluster identity may be rotated from server 304 to server 306. When the router 310 sends a request inquiring which MAC address maps to IP address A, server 304, 306, and/or 308 would respond with the MAC address X₂. Alternatively, after obtaining the cluster identity, server 306 may send a gratuitous response, such as a gratuitous ARP, that indicates a mapping of the IP address A to MAC address X₂ so that router 310 may update its router table. After the router table of router 310 is updated to map IP address A to MAC address X₂, incoming packets with a destination IP address of A would be forwarded to server 306. After a predetermined amount of time, the cluster identity would be rotated from server 306 to another server in the system 300, and the process continues.

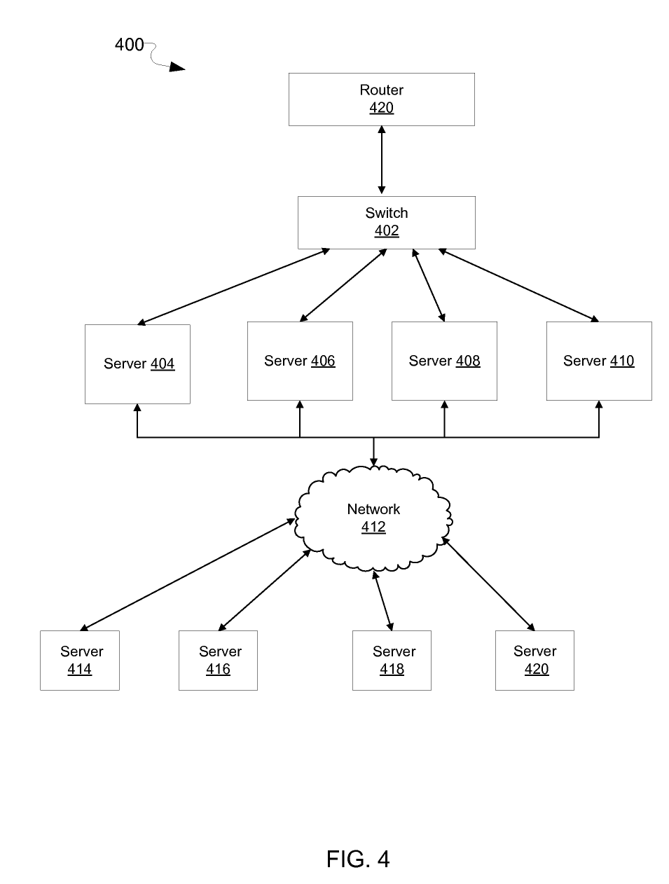

FIG. 4 is a block diagram illustrating an exemplary two-tier system 400 for rotation of cluster identity. System 400 includes a router 420, a switch 402, a plurality of first-tier or front-end servers, such as 404, 406, 408, and 410, and a plurality of second-tier or back-end servers, such as 414, 416, 418, and 420. The second-tier servers are coupled to the first-tier servers via a network 412. Traffic is load balanced among the first-tier servers via rotation of cluster identity. The rotation of cluster identity may be accomplished via MAC address plumbing as described above with respect to FIG. 1, MAC address spoofing as described above with respect to FIG. 2, or via a mapping of a cluster IP address to a server MAC address as described above with respect to FIG. 3.

In the systems of FIGS. 1, 2, and 3, when a server that owns the cluster identity receives a packet, the server may determine that the packet is part of a flow, session, or stream of packets that are being processed by another server in the system. The server would then forward the packet to the other server that is hosting or processing the flow, session, or series of packets. This may create network traffic among the servers in the cluster.

As shown in FIG. 4, in system 400, the processing of the packets is done by the second-tier or back-end servers. When a first-tier server that owns the cluster identity receives a packet, the first-tier server decides which second-tier server will process the packet, and then sends the packet to that second-tier server. The packet is then processed by the second-tier server. For example, if server 408 currently owns the cluster identity, switch 402 will send incoming packets to server 408. Server 408 will then decide whether to forward each incoming packet to server 414, 416, 418, or 420 for processing. The server 408 may make its decisions based at least in part on preservation of flows, sessions, or streams of packets.

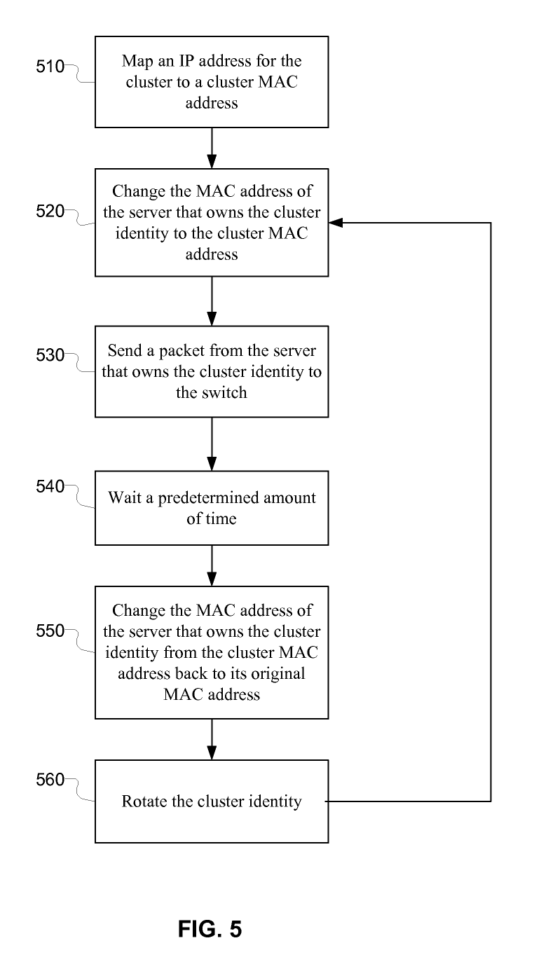

FIGS. 5-7 are flow diagrams illustrating exemplary processes for rotation of cluster identity. While the description of FIGS. 5-7 may be made with reference to other figures, it should be understood that the exemplary processes illustrated in FIGS. 5-7 are not intended to be limited to being associated with the systems or other contents of any specific figure or figures. Additionally, it should be understood that while the exemplary processes of FIGS. 5-7 indicate a particular order of operation execution, in one or more alternative implementations, the operations may be ordered differently. Furthermore, some of the steps and data illustrated in the exemplary processes of FIGS. 5-7 may not be necessary and may be omitted in some implementations. Finally, while the exemplary processes of FIGS. 5-7 contains multiple discrete steps, it should be recognized that in some environments some of these operations may be combined and executed at the same time.

FIG. 5 is a flow diagram illustrating an exemplary process for rotation of cluster identity via MAC address plumbing. At 510, an IP address for a cluster of servers is mapped to a cluster MAC address. For example, the IP address of A may be mapped to the MAC address X. A cluster identity is assigned to one of the servers in the cluster. At 520, the MAC address of the server owning the cluster identity is replaced with the cluster MAC address. For example, a first server in the cluster may have a MAC address of X₁, which is replaced by the MAC address X. At 530, a packet is sent from the server owning the cluster identity to a switch. One or more packets may then be received at the server owning the cluster identity from the switch. After waiting a predetermined amount of time at 540, the MAC address of the server owning the cluster identity is replaced with its original MAC address at 550. For example, the MAC address of the first server may be changed from X back to X₁. At 560, the cluster identity is rotated to another server in the cluster. For example, the cluster identity may be rotated from the first server to a second server in the cluster. Then, the process is repeated from step 520.

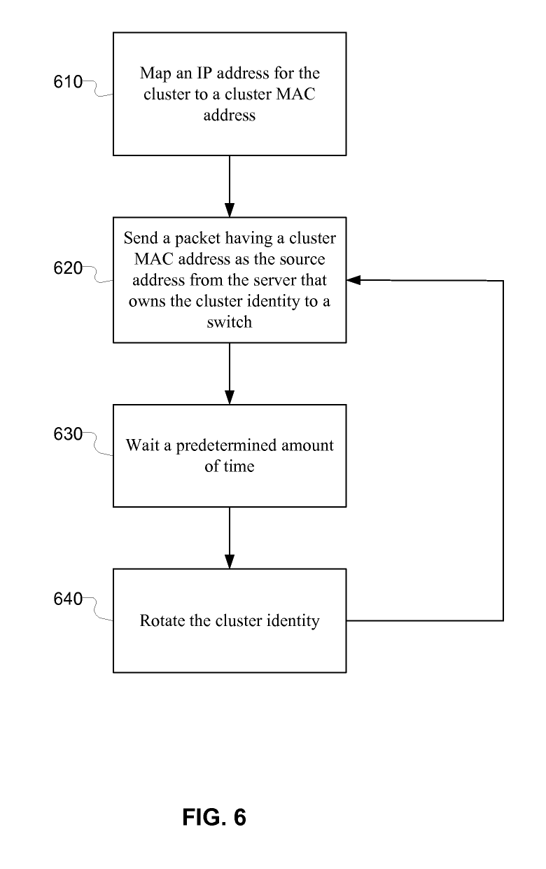

FIG. 6 is a flow diagram illustrating an exemplary process for rotation of cluster identity via MAC address spoofing. Each server in a cluster of servers is configured to have the same virtual IP address and the same MAC address. At 610, an IP address for the cluster of servers is mapped to a cluster MAC address. One of the servers in a cluster is assigned the cluster identity. At 620, a packet having the cluster MAC address as the source address is sent from the server owning the cluster identity to a switch. One or more packets may be received at the server owning the cluster identity from the switch. Any packets sent from any server that does not own the cluster identity have a source address that is different from the cluster MAC address. After waiting a predetermined amount of time at 630, the cluster identity is rotated to another server in the cluster at 640. Then, the process is repeated from step 620.

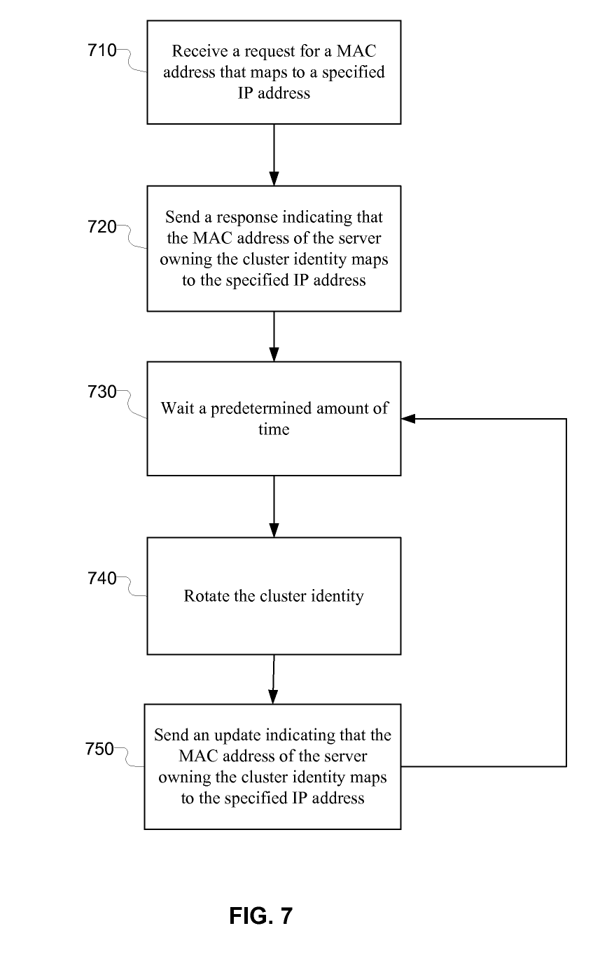

FIG. 7 is a flow diagram illustrating an exemplary process for rotation of cluster identity via a mapping of a cluster IP address to a server MAC address. At 710, a request is received for a MAC address that maps to a specified IP address. The request may be an ARP request received from a router. At 720, a response is sent indicating that the MAC address of the server owning the cluster identity maps to the specified IP address. Upon receipt of the response, the router may update its router table to map the specified IP address to the MAC address of the server owning the cluster identity. Then, packets with the specified IP address as the destination address would be forwarded to the server owning the cluster identity. After waiting a predetermined amount of time at 730, the cluster identity is rotated to another server in the cluster at 740. At 750, an update is sent indicating that the MAC address of the server owning the cluster identity maps to the specified IP address. The update may be a gratuitous ARP sent to the router to tell the router to update its router table to map the specified IP address to the MAC address of the server owning the cluster identity. Then, the process is repeated from step 730.

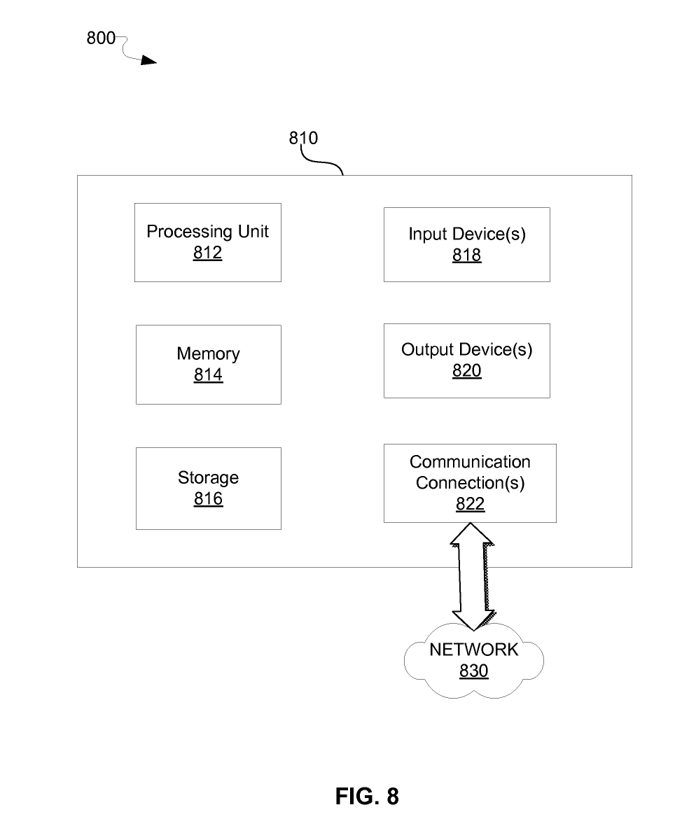

FIG. 8 illustrates an exemplary computing environment in which certain aspects of the invention may be implemented. It should be understood that computing environment 800 is only one example of a suitable computing environment in which the various technologies described herein may be employed and is not intended to suggest any limitation as to the scope of use or functionality of the technologies described herein. Neither should the computing environment 800 be interpreted as necessarily requiring all of the components illustrated therein.

The technologies described herein may be operational with numerous other general purpose or special purpose computing environments or configurations. Examples of well known computing environments and/or configurations that may be suitable for use with the technologies described herein include, but are not limited to, personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

With reference to FIG. 8, computing environment 800 includes a general purpose computing device 810. Components of computing device 810 may include, but are not limited to, a processing unit 812, a memory 814, a storage device 816, input device(s) 818, output device(s) 820, and communications connection(s) 822.

Processing unit 812 may include one or more general or special purpose processors, ASICs, or programmable logic chips. Depending on the configuration and type of computing device, memory 814 may be volatile (such as RAM), non-volatile (such as ROM, flash memory, etc.) or some combination of the two. Computing device 810 may also include additional storage (removable and/or non-removable) including, but not limited to, magnetic or optical disks or tape. Such additional storage is illustrated in FIG. 8 by storage 816. Computer storage media includes volatile and nonvolatile, removable and non-removable media implemented in any method or technology for storage of information such as computer readable instructions, data structures, program modules or other data. Memory 814 and storage 816 are examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 810. Any such computer storage media may be part of computing device 810.

Computing device 810 may also contain communication connection(s) 822 that allow the computing device 810 to communicate with other devices, such as with other computing devices through network 830. Communications connection(s) 822 is an example of communication media. Communication media typically embodies computer readable instructions, data structures, program modules or other data in a modulated data signal such as a carrier wave or other transport mechanism and includes any information delivery media. The term ‘modulated data signal’ means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes storage media.

Computing device 810 may also have input device(s) 818 such as a keyboard, a mouse, a pen, a voice input device, a touch input device, and/or any other input device. Output device(s) 820 such as one or more displays, speakers, printers, and/or any other output device may also be included.

While the invention has been described in terms of several exemplary implementations, those of ordinary skill in the art will recognize that the invention is not limited to the implementations described, but can be practiced with modification and alteration within the spirit and scope of the appended claims. The description is thus to be regarded as illustrative instead of limiting.

1. A method for rotating a cluster identity among a cluster of servers comprising:
mapping an Internet Protocol (IP) address for the cluster of servers to a cluster Media Access Control (MAC) address;
changing a first MAC address of a first server in the cluster to the cluster MAC address;
receiving a first packet from a switch, the first packet having the cluster MAC address as its destination;
changing a second MAC address of a second server in the cluster to the cluster MAC address; and
changing the first server's MAC address back to the first MAC address.

2. The method of claim 1, further comprising sending a second packet from the second server to the switch, wherein the second packet has the cluster MAC address as a source address.

3. The method of claim 2, wherein the second packet sent from the second server is a membership heartbeat packet.

4. The method of claim 2, further comprising receiving a third packet at the second server from the switch, the third packet having the cluster MAC address as its destination.

5. The method of claim 4, further comprising forwarding the third packet to another server for processing.

6. The method of claim 1, further comprising changing a third MAC address of a third server in the cluster to the cluster MAC address.

7. The method of claim 6, further comprising changing the second server's MAC address back to the second MAC address.

8. One or more device-readable media with device-executable instructions for performing steps comprising:
sending a first packet to a switch from a first server in a cluster of servers, wherein the first packet has a cluster Media Access Control (MAC) address as its source address;
rotating a cluster identity from the first server to a second server in the cluster;
sending a second packet from the second server to the switch, wherein the second packet has the cluster MAC address as its source address; and
sending a third packet from the first server to the switch, wherein the third packet has a first MAC address as its source address, and the first MAC address is different from the cluster MAC address.

9. The one or more device-readable media of claim 8, wherein the second packet is a gratuitous packet.

10. The one or more device-readable media of claim 8, wherein the steps further comprise receiving a fourth packet at the second server from the switch, the fourth packet having the cluster MAC address as its destination.

11. The one or more device-readable media of claim 10, wherein the steps further comprise forwarding the fourth packet to another server for processing.

12. The one or more device-readable media of claim 10, wherein the steps further comprise rotating the cluster identity from the second server to a third server in the cluster.

13. The one or more device-readable media of claim 12, wherein the steps further comprise sending a fifth packet from the third server to the switch, wherein the fifth packet has the cluster MAC address as its source address.

14. The one or more device-readable media of claim 13, wherein the steps further comprise receiving a sixth packet at the third server from the switch, the sixth packet having the cluster MAC address as its destination.

15. The one or more device-readable media of claim 14, wherein the steps further comprise sending a seventh packet from the second server to the switch, wherein the seventh packet has a second MAC address as its source address.

16. The one or more device-readable media of claim 15, wherein the second MAC address is different from the cluster MAC address and the first MAC address.

17. A method comprising:
receiving a request for a cluster Media Access Control (MAC) address that maps to a specified Internet Protocol (IP) address;
sending a reply indicating a first MAC address as the cluster MAC address that maps to the specified IP address, the first MAC address associated with a first server in a cluster of servers;
rotating a cluster identity from the first server to a second server in the cluster; and
sending an update indicating a second MAC address as the cluster MAC address that maps to the specified IP address, the second MAC address associated with the second server.

18. The method of claim 17, further comprising updating a router table to map the second MAC address to the specified IP address.

19. The method of claim 17, wherein the received request is an Address Resolution Protocol (ARP) request.

20. The method of claim 17, further comprising receiving a packet at the second server and forwarding the packet to another server for processing.
